(19) United States
(12) Patent Application Publication
(10) Pub. No.: US 2025/0371948 A1
(43) Pub. Date: Dec. 4, 2025

(54) Haptic Feedback Device

(71) Applicant: AAC Acoustic Technologies (Shanghai) Co., Ltd., Shanghai (CN)

(72) Inventors: Hongguang Li, Shanghai (CN); Hanliang Shen, Shanghai (CN); Gangrui Liang, Shanghai (CN); Shuai Ma, Shanghai (CN)

(21) Appl. No.: 18/974,721

(22) Filed: Dec. 9, 2024

Related U.S. Application Data
(63) Continuation of application No. PCT/CN2024/096267, filed on May 30, 2024.

(51) Int. Cl. G08B 6/00

(52) U.S. Cl. CPC G08B 6/00

(57) ABSTRACT

The present invention provides a haptic feedback device including a suspension and a fixing assembly. The suspension assembly includes a housing, at least one linear shaft, and a vibration motor. The fixing assembly includes a base enclosing a receiving space and at least one bearing member. The housing is spaced apart from the base. The linear shaft passes through the bearing member and extends beyond the bearing member. The vibration motor drives the suspension assembly to move reciprocally. The suspension assembly of the present invention can retain the vibration freedom only in a single direction, and the distribution of vibration sensation is more uniform. The vibration sensation transmitted to the fixed assembly is small, and the vibration sensation is more concentrated on the suspension assembly. When the suspension assembly is applied by an external pressure, the pressure has little effect on the vibration sensation intensity.

### FIELD OF THE PRESENT INVENTION

The present invention relates to the field of vibration haptic, and more particularly, to a haptic feedback device.

### DESCRIPTION OF RELATED ART

In the field of vibration haptic, in order to show a good local vibration sensation of a product, the vibration device must be installed on a well-designed suspension structure. The traditional suspension structure is to use metal shrapnel or flexible material to connect the suspension assembly and non-suspension assembly. The shrapnel or flexible materials acted as the traditional suspension structures, the vibration sensation of the suspension structures can not be retained in a single direction of freedom, thus affecting the uniformity of distribution of the vibration sensation of the suspension assembly, and the suspension assembly will transmit a larger vibration sensation to the non-suspension assembly. When the suspension assembly is applied by an external pressure, the resonant frequency of the suspension assembly will be greatly affected, the practicality of the suspension assembly is greatly reduced. The applications of the different scenarios are subjected to a greater degree of limitation.

Therefore, it is desired to provide a new haptic feedback device which can overcome the above problems.

### SUMMARY

In view of the above, the embodiments of the present invention provide a new haptic feedback device, the area of the vibration sense of the tactile feedback of the haptic feedback device is concentrated, and types of vibration senses are diverse.

The present invention provides a haptic feedback device including a suspension assembly and a fixing assembly supporting the suspension assembly. The suspension assembly includes a housing, at least one linear shaft fixed under the housing, and a vibration motor fixed under the housing. The fixing assembly includes a base enclosing a receiving space and at least one bearing member corresponding to the linear shaft mounted in the receiving space. The housing is arranged spaced apart from the base. The linear shaft is disposed passing through the bearing member and extends beyond the bearing member. The vibration motor drives the suspension assembly to move reciprocally relative to the fixing assembly along an axial direction of the linear shaft.

As an improvement, the linear shaft is made of metal material, and/or the bearing member is made of metal material.

As an improvement, the housing includes a main body with a plate shape and a plurality of protruding portions extending from the main body into the receiving space, and the linear shaft is fixed to the protruding portions.

As an improvement, each protruding portion is provided with a through hole penetrating therethrough, and the linear shaft is penetrated in the through hole and is firmly connected to the protruding portion.

As an improvement, the main body and the protruding portions are integrally formed.

As an improvement, the housing is provided with two protruding portions corresponding to each linear shaft, and each linear shaft passes through the through holes of the two protruding portions.

As an improvement, the linear shaft includes two outer end surfaces, one outer end surface of the linear shaft extending not beyond one of the protruding portions, and the other outer end surface of the linear shaft extending not beyond the other of the protruding portions.

As an improvement, the base includes a bottom wall and a side wall bending and extending from the bottom wall, the bottom wall and the side wall cooperative to form the receiving space, the bottom wall provided with a plurality of protrusions extending into the receiving space, and the bearing member mounted and fixed on the protrusions.

As an improvement, an arc-shaped groove is provided on a surface of each protrusion, and a shape of the groove matches a shape of a surface of the bearing member.

As an improvement, the base is provided with two protrusions corresponding to each bearing member, and each bearing member is supported on two protrusions.

### BRIEF DESCRIPTION OF THE DRAWINGS

Many aspects of the exemplary embodiments can be better understood with reference to the following drawing. The components in the drawing are not necessarily drawn to scale, the emphasis instead being placed upon clearly illustrating the principles of the present invention. Moreover, in the drawings, like reference numerals designate corresponding parts throughout the several views.

FIG. 1 is an illustrative isometric view of a haptic feedback device in accordance with one embodiment of the present invention.

FIG. 2 is a partially exploded view of the haptic feedback device of FIG. 1.

FIG. 3 is another partially exploded view of the haptic feedback device of FIG. 1 from another perspective.

FIG. 4 is an exploded view of the haptic feedback device of FIG. 1.

FIG. 5 is an illustrative cross-sectional view of the haptic feedback device taken along line A-A of FIG. 1.

### DETAILED DESCRIPTION OF THE EXEMPLARY EMBODIMENTS

The present invention will hereinafter be described in detail with reference to exemplary embodiments. To make the technical problems to be solved, technical solutions and beneficial effects of the present invention more apparent, the present invention is described in further detail together with the figures and the embodiments. It should be understood the specific embodiments described hereby is only to explain the disclosure, not intended to limit the disclosure.

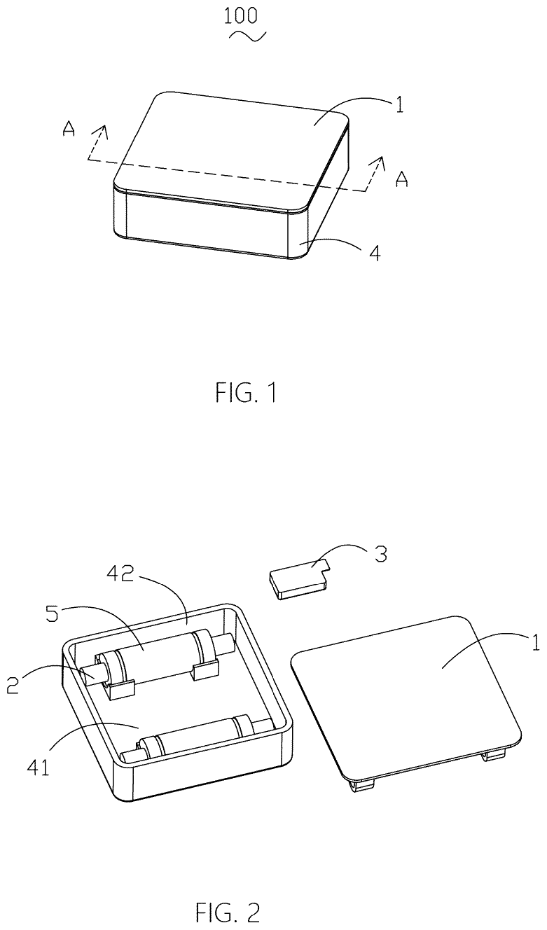

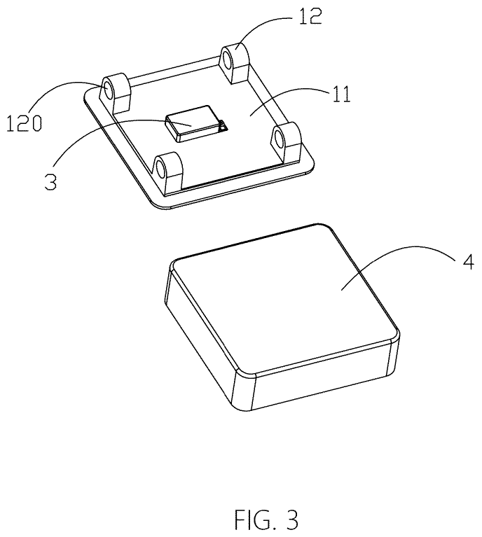

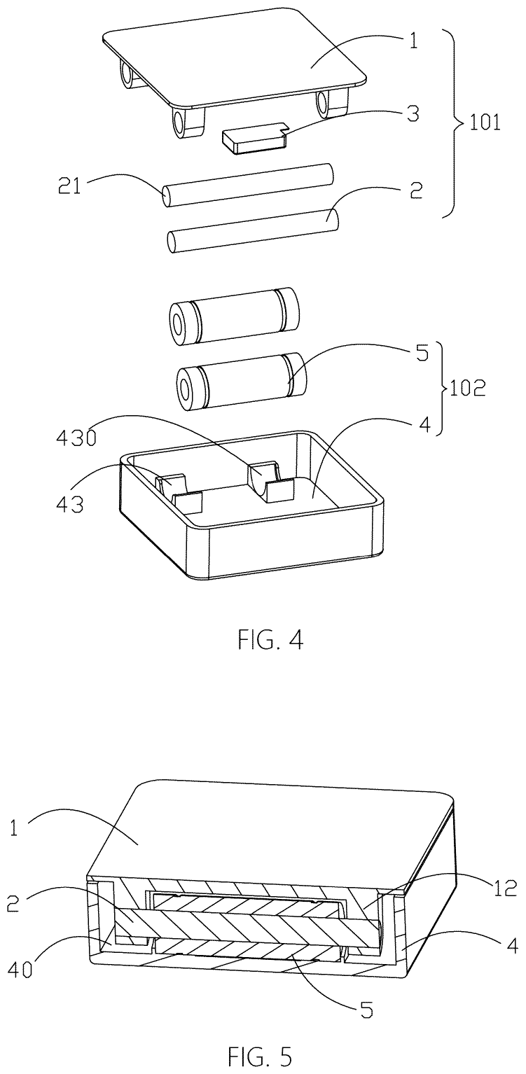

Referring to the FIGS. 1-5, the present invention provides one embodiment of a haptic feedback device 100. The haptic feedback device 100 includes a suspension assembly 101 and a fixing assembly 102 supporting the suspension assembly 101. The suspension assembly 101 includes a housing 1, at least one linear shaft 2 fixed under the housing 1, and a vibration motor 3 fixed under the housing 1 and mounted on a lower surface of the housing 1. The fixing assembly 102 includes a base 4 enclosing a receiving space 40 and at least one bearing member 5 corresponding to the linear shaft 2 and mounted in the receiving space 40. The suspension assembly 10 can move reciprocally relative to the fixing assembly 102 along an axial direction of the linear shaft 2 to provide vibration sensation.

The housing 1 includes a main body 11 with a plate shape and a plurality of protruding portions 12 extending from the main body 11 into the receiving space 40. The main body 11 and the protruding portions 12 are integrally formed. In other embodiments, the main body 11 and the protruding portions 12 may also be secured by other means, e.g. glued. The number of the protruding portions 12 is two pairs, and the main body 11 is provided with two pairs of the protruding portions 12 spaced from each other in vibration direction of the suspension assembly 101. One linear shaft 2 is corresponding to two protruding portions 12. One linear shaft 2 is penetrated through two protruding portions 12 at the same time.

The linear shaft 2 is fixed to the protruding portions 12. Specifically, each protruding portion 12 is provided with a through hole 120 penetrating therethrough, and the linear shaft 2 is penetrated in the through hole 120 and is firmly connected to the protruding portion 12, so that, the linear shaft 2 can bring the housing 1 to slide together.

Each linear shaft 2 includes two outer end surfaces 21, one outer end surface 21 of the linear shaft 2 extends not beyond one of the protruding portions 12, and the other outer end surface 21 of the linear shaft 2 extends not beyond the other of the protruding portions 12. The outer end surface 21 of the linear shaft 2 is spaced apart from the base 4 to provide enough space for the suspension assembly 101, so as to ensure that the suspension assembly 101 has enough amplitude. The linear shaft 2 is made of metal material. In present embodiment, the number of the linear shafts 2 is two, and each linear shaft 2 has a cylindrical shape. In other embodiments, the number of the linear shafts 2 can be set according to demand, and the shape of the linear shafts 2 can also be rectangular columns.

The vibration motor 3 is disposed at a middle position of the main body 11 of the housing 1 to better drive the suspension assembly 101 to slide back and forth along the axial direction of the linear shaft 2.

The base 4 is arranged spaced apart from the housing 1. The base 4 includes a bottom wall 41 and a side wall 42 bending and extending from the bottom wall 41. The bottom wall 41 and the side wall 42 are cooperative to form the receiving space 40. The bottom wall 41 provides with a plurality of protrusions 43 extending into the receiving space 40. And the bearing member 5 is mounted and fixed on the protrusions 43. An arc-shaped groove 430 is provided on a surface of each protrusion 43, and a shape of the groove 430 matches a shape of a surface of the bearing member 5.

The number of the protrusions 43 is two pairs, and bottom wall 41 being provided with two pairs of the protrusions 43 spaced from each other in vibration direction of the suspension assembly 101. That is one bearing member 5 is corresponding to two protrusions 43. One bearing member 5 is supported on two protrusions 43.

The bearing member 5 is made of metal material. The linear shaft 2 is disposed passing through the bearing member 5 and extends beyond the bearing member 5. Optionally, both the linear shaft 2 and the bearing member 5 are made of metal material. In this way, a friction between the linear shaft 2 and the bearing member 5 will be very small, and an effect on the vibration sensation of the suspension assembly 101 will be also smaller. While when there is an external pressure acting on the housing 1, the effect of the friction will be smaller, and the pressure has little effect on the intensity of the vibration sensation of the housing 1.

The bearing member 5 are cooperative with the linear shaft 2 to make the movement of the suspension assembly 101 relative to the fixed assembly 102 only have one freedom degree along the axial direction of the linear shaft 2. When the suspension assembly 101 vibrates, the suspension assembly 101 can only vibrate along the axial direction of the linear shaft 2, and there is no excess vibration in other directions, so that the distribution of vibration sensation of the housing 1 is more uniform. After the haptic feedback device 100 assembling, due to the friction coefficient between the bearing member 5 and the linear shaft 2 is very small, which makes it difficult for the vibration sensation of the housing 1 to be transmitted to the base 4, so that the vibration sensation is concentrated on the suspension assembly 101, and the effect of haptic feedback device is good.

Comparing with the related art, the present invention provides a haptic feedback device including a suspension assembly and a fixing assembly supporting the suspension assembly. The suspension assembly includes a housing, at least one linear shaft fixed under the housing, and a vibration motor fixed under the housing. The fixing assembly includes a base enclosing a receiving space and at least one bearing member corresponding to the linear shaft mounted in the receiving space. The housing is arranged spaced apart from the base. The linear shaft is disposed passing through the bearing member and extends beyond the bearing member. The vibration motor drives the suspension assembly to move reciprocally relative to the fixing assembly along an axial direction of the linear shaft.

The haptic feedback device of present invention using the linear shaft and the bearing member to realize the fixation of the suspension assembly, so that the suspension assembly retains only one freedom degree of the vibration with a single direct, and the distribution of vibration sensation is more uniform. The vibration sensation transmitted to the fixed assembly is small, and the vibration sensation is more concentrated on the suspension assembly. When the suspension assembly is applied by an external pressure, the pressure has little effect on the intensity of the vibration sensation of the housing 1. Therefore, the present invention improves the shortcomings of traditional suspension structures while retaining the functions of the traditional suspension structures.

It is to be understood, however, that even though numerous characteristics and advantages of the present exemplary embodiments have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A haptic feedback device, comprising:
a suspension assembly, the suspension assembly comprising:
a housing;
at least one linear shaft fixed under the housing; and
a vibration motor fixed under the housing; and
a fixing assembly supporting the suspension assembly, the fixing assembly comprising:
a base enclosing a receiving space; and
at least one bearing member corresponding to the linear shaft mounted in the receiving space;
wherein the housing is arranged spaced apart from the base, the linear shaft is disposed passing through the bearing member and extends beyond the bearing member, and the vibration motor drives the suspension assembly to move reciprocally relative to the fixing assembly along an axial direction of the linear shaft.

2. The haptic feedback device as described in claim 1, wherein the linear shaft is made of metal material, and/or the bearing member is made of metal material.

3. The haptic feedback device as described in claim 2, wherein the housing comprises a main body with a plate shape and a plurality of protruding portions extending from the main body into the receiving space, and the linear shaft is fixed to the protruding portions.

4. The haptic feedback device as described in claim 3, wherein each protruding portion is provided with a through hole penetrating therethrough, and the linear shaft is penetrated in the through hole and is firmly connected to the protruding portion.

5. The haptic feedback device as described in claim 3, wherein the main body and the protruding portions are integrally formed.

6. The haptic feedback device as described in claim 4, wherein the housing is provided with two protruding portions corresponding to each linear shaft, and each linear shaft passes through the through holes of the two protruding portions.

7. The haptic feedback device as described in claim 6, wherein the linear shaft comprises two outer end surfaces, one outer end surface of the linear shaft extending not beyond one of the protruding portions, and the other outer end surface of the linear shaft extending not beyond the other of the protruding portions.

8. The haptic feedback device as described in claim 1, wherein the base comprises a bottom wall and a side wall bending and extending from the bottom wall, the bottom wall and the side wall cooperative to form the receiving space, the bottom wall provided with a plurality of protrusions extending into the receiving space, and the bearing member mounted and fixed on the protrusions.

9. The haptic feedback device as described in claim 8, wherein an arc-shaped groove is provided on a surface of each protrusion, and a shape of the groove matches a shape of a surface of the bearing member.

10. The haptic feedback device as described in claim 8, wherein the base is provided with two protrusions corresponding to each bearing member, and each bearing member is supported on two protrusions.
